(19) United States
(12) Patent Application Publication
(10) Pub. No.: US 2009/0239019 A1
(43) Pub. Date: Sep. 24, 2009

(54) Relating To Materials

(76) Inventor: Adrian Merritt, Alvechurch (GB)

Correspondence Address: PASSE' INTELLECTUAL PROPERTY, LLC, 1717 BRASSFIELD RD., RALEIGH, NC, 27614, US

(21) Appl. No.: 12/302,355

(22) PCT Filed: May 23, 2007
(86) PCT No.: PCT/GB2007/001943

§ 371 Date: Feb. 27, 2009

(30) Foreign Application Priority Data
May 25, 2006 (GB) 0610381.6

(51) Int. Cl. B65G 49/06; B29D 7/00; B32B 3/16; B65H 18/08

(52) U.S. Cl. 428/40.4; 264/145; 264/139; 428/194; 428/57; 242/520; 242/538

(57) ABSTRACT

The invention provides a method of manufacturing a plurality of spacers comprising: (a) providing a carrier medium; (b) applying one or more stripes of a first material on a first face of the carrier medium; and (c) applying a layer of a second material over the first face of the carrier medium; so as to form a substrate on the carrier medium comprising first material and second material;

wherein one of the first and second materials is a material that, in the end spacer product at room temperature, is a tacky material that will readily hold the spacer in place during its intended use, and the other of the first and second materials is a material that, in the end spacer product at room temperature, is a non-tacky material that will substantially not stick to the glass or other material to be separated;
and wherein the stripes of the first material are spaced apart such that when the substrate formed by the first and second materials is cut into strips of a width corresponding to the width of the spacers being produced, one or more of the cut edges of each strip includes a portion of the non-tacky material.

This invention concerns improvements in and relating to materials, particularly of the type used to space glass and other materials during handling storage and transportation, particularly those of sheet form, and to improvements in and relating to the manufacture of such materials.

Glass sheets arrive from the manufacturers in stacks of sheets of one size in a purpose built frame. However, during subsequent processing and handling spacing elements are used to keep the individual glass elements apart with a view to easing handling and avoid damage due to relative movement or foreign bodies being caught between sheets.

As many sets of spacers may be required during the overall process life of the glass, spacers must be cheap to produce; and not damage the glass as well as offering suitable padding levels. Above all the spacers must be easily applied and removed.

A number of different materials can and have been employed as spacers. Amongst the earliest techniques was the introduction of a piece of paper between the sheets. However, paper offers limited crush resistance or padding and is awkward to handle.

As an alternative, spacers provided as a series of discrete blocks that are placed at various locations on the glass have been used. A number of such spacer types exist, such as cork and PVC composites or a foam pad. When applied without an adhesive on one side to hold the pad in position the spacer frequently and inconveniently falls off. When provided with an adhesive the spacer sometimes bonds too well and is difficult to remove, decreasing productivity. “Fingerlift” spacers have however been provided (EP-B-0 855 353), which include an edge section that is not provided with adhesive, such that a finger or other means employed to remove the spacer can easily lift a portion of the edge relative to the remainder of the spaced element.

However existing processes for producing spacer elements of various forms often include a significant number of steps and may be complex, for example requiring the process to be carried out in more than one factory. Clearly such processes are expensive and also, due to the number of steps involved and their complexity, are vulnerable to breakdown.

There is therefore a need for a straightforward production process for spacer elements, such as “Fingerlift” spacer elements, which involves a relatively small number of steps.

According to a first aspect of the invention there is provided a method of manufacturing a plurality of spacers comprising:

a) providing a carrier medium;
b) applying one or more stripes of a first material on a first face of the carrier medium; and
c) applying a layer of a second material over the first face of the carrier medium;
so as to form a substrate on the carrier medium comprising first material and second material;
wherein one of the first and second materials is a material that, in the end spacer product at room temperature, is a tacky material that will readily hold the spacer in place during its intended use, and the other of the first and second materials is a material that, in the end spacer product at room temperature, is a non-tacky material that will substantially not stick to the glass or other material to be separated; and wherein the stripes of the first material are spaced apart such that when the substrate formed by the first and second materials is cut into strips of a width corresponding to the width of the spacers being produced, one or more of the cut edges of each strip includes a portion of the non-tacky material.

When reference is made to tacky material this may be a single tacky material or two or more tacky materials. Further, the tacky material may be applied in a single application/layer or in two or more applications/layers in order to provide the required tacky material.

It will be clear to the skilled man that the properties of the tacky material when it is applied to the carrier medium may not be the same as those of the material when it is in the end spacer product. The present invention requires that material be used as the tacky material that will, following the production of the spacer product, be sufficiently tacky at room temperature that it will readily hold the spacer in place during its intended use, such as in spacing sheets of glass. Accordingly, appropriate material should be selected in view of the various production steps intended to be carried out to arrive at the spacer product.

Preferred tacky materials are ones that, in the end spacer product at room temperature, will readily hold the spacer in place during its intended use, such as in spacing sheets of glass, but that will easily and cleanly remove from its use position, such as on the glass and/or other material being spaced, when no longer required.

The tacky material is suitably a material that, in the end spacer product at room temperature, is sufficiently tacky that when applied to a clean piece of glass when held in a vertical position it will stick for one minute or more, preferably five minutes or more, more preferably 10 minutes or more, most preferably 20 minutes or more, such as 30 minutes or more, for example an hour or more, such as 24 hours or more.

The tacky material is suitably a material that, in the end spacer product at room temperature, is sufficiently tacky that when applied to a clean piece of glass when held in a horizontal position, with the tacky material on the face of the glass that is facing downward, it will stick for one minute or more, preferably five minutes or more, more preferably 10 minutes or more, most preferably 20 minutes or more, such as 30 minutes or more, for example an hour or more, such as 24 hours or more.

The tacky material is suitably a material that, in the end spacer product at room temperature, can, however, be easily removed from a clean sheet of glass. Preferably, the material can be easily removed from a clean sheet of glass, leaving no immediately apparent markings on the glass. More preferably, the material can be easily removed from a clean sheet of glass, leaving no immediately apparent markings on the glass, after having been stuck to the glass for one minute or more, preferably five minutes or more, more preferably 10 minutes or more, most preferably 20 minutes or more, such as 30 minutes or more, for example an hour or more.

When reference is made to non-tacky material this may be a single non-tacky material or two or more non-tacky materials. Further, the non-tacky material may be applied in a single application/layer or in two or more applications/layers in order to provide the required non-tacky material.

It will be clear to the skilled man that the properties of the non-tacky material when it is applied to the carrier medium may not be the same as those of the material when it is in the end spacer product. The present invention requires that material be used as the non-tacky material that will, following the production of the spacer product, be sufficiently non-tacky at room temperature that it will substantially not stick to the glass or other material to be separated. Accordingly, appropriate material should be selected in view of the various production steps intended to be carried out to arrive at the spacer product.

Preferred non-tacky materials are ones that, in the end spacer product at room temperature, are sufficiently non-tacky that when applied to a clean piece of glass when held in a vertical position they will stick for not more than 30 seconds, more preferably not more than 10 seconds, most preferably not more than 5 seconds, such as not more than 2 seconds, for example not more than 1 second.

It is preferred that the non-tacky material, in the end spacer product at room temperature, is sufficiently non-tacky that when applied to a clean piece of glass when held in a vertical position it does not stick at all.

The method may further include the step of:

cutting the substrate formed by the first and second materials into a plurality of strips of a width corresponding to n times the width of the spacers being produced, where n is an integer, such that these strips can subsequently be cut into n strips, each of a width corresponding to the width of the spacers being produced.

Clearly, this is advantageous as there is no wastage produced. However, if desired the substrate could be cut into a plurality of strips of a width corresponding to greater than n times the width of the spacers being produced. Then if these strips were subsequently cut into n strips, each of a width corresponding to the width of the spacers being produced, there would be a degree of wastage.

Preferably the method includes the step of:

d) cutting the substrate formed by the first and second materials into a plurality of strips of a width corresponding to the width of the spacers being produced, such that one or more of the cut edges of each strip includes a portion of the non-tacky material.

In step (d) the substrate may be directly cut into strips of a width corresponding to the width of the spacers being produced, or the substrate may firstly be cut into strips having a greater width, which are subsequently cut into strips of a width corresponding to the width of the spacers being produced.

The method is relatively simple and straightforward, involving a small number of steps and not requiring transfer between factories.

Preferably, the first material that is applied in stripes is a tacky material and the second material is a non-tacky material. However, in an alternative embodiment the first material is a non-tacky material and the second material is a tacky material.

The one or more stripes of the first material applied to the carrier medium may each independently be any suitable width. Preferably, each stripe applied is of substantially the same width but in one embodiment the stripes applied are of differing widths.

Preferably the first material is applied in stripes having a width of from a fifth to three-quarters of the width of the spacer to be cut, for example from a quarter to a half of the width of the spacer to be cut, although the stripes may be wider or narrower. An equivalent or larger or smaller width may be provided between adjacent stripes. Suitably a width may be provided between adjacent stripes such that there are from one to ten or more stripes of the first material per spacer, preferably from one to six stripes per spacer, for example one or two or three or four or five or more stripes per spacer, such as one or two or three stripes per spacer.

The stripes of the first material may be continuous or discontinuous, for example the first material may be applied in one or more single continuous stripe or in multiple sections making up one or more stripe, e.g. random or regularly spaced dots or dashes.

The application of the first material in a regularly spaced discontinuous form, such as a regularly spaced pattern, or regularly spaced series of dots or dashes, may aid the use of the spacer or ease of manufacture as well as reducing manufacturing costs.

The use of stripes of first material in a method in accordance with the present invention is particularly advantageous where it is desired to apply the spacer by means of semi-automatic or automatic dispensers as are currently employed on production lines or in other continuous manufacturing environments.

The layer of the second material that is applied in step (c) is preferably applied over all of the first face of the carrier medium that is not covered by stripes of first material. Suitably the layer of the second material that is applied in step (c) is applied over all of the first face of the carrier medium that is not covered by stripes of first material and over all of the stripes of the first material. However, in one embodiment it may cover only part of the stripes of the first material and/or only part of the first face of the carrier medium. For example, the layer of the second material may be applied over most or all of the carrier medium that is not covered by stripes of the first material and none, part or all of the stripes of the first material.

Preferably each spacer generated has an edge portion with non-tacky material, achieved with or without a degree of wastage.

The stripes of first material may be any suitable depth in view of the intended application. Suitably, the stripes of the first material may be applied so as to have a depth of 3 mm or less, such as 2 mm or less, preferably 1 mm or less, for example 0.5 mm, such as 0.25 mm or less. For example, the stripes may be applied to have a depth of from 0.1 mm to 1 mm, such as from 0.25 mm to 0.75 mm.

The stripes of first material may have a depth less than or equal to the depth of the substrate formed by the first and second materials. The stripes of first material may have a depth of three quarters or less of the depth of the substrate formed by the first and second materials, for example a depth of half or less of the depth of the substrate formed by the first and second materials, such as a depth of a third of the depth of the substrate formed by the first and second materials. For example, the stripes of first material may have a depth of from one quarter to three quarters of the depth of the substrate formed by the first and second materials, e.g. from one quarter to a half of the depth of the substrate formed by the first and second materials, such as from one third to a half of the depth of the substrate formed by the first and second materials.

The layer of second material may be any suitable depth in view of the intended application. Suitably, the layer of the second material may be applied so as to have a depth of 1 mm or more, e.g. 1 mm to 5 mm, preferably 1.5 mm or more, e.g. 1.5 mm to 4 mm, more preferably 2 mm or more, such as 2 mm to 3 mm, e.g. 2.5 mm to 3 mm, for example 3 mm.

In the event that the first and/or second material is expandable, e.g. foamable, material, it may be applied in a depth less than the intended depth and then expanded, e.g. foamed, such that the intended depth is achieved.

If the second material is applied over both the first face of the carrier medium that is not covered by stripes of first material and the stripes of the first material then it is preferred that the second material is applied such that the substrate formed by the first material and second material is of a substantially constant depth. Accordingly, the second material is suitably applied over the stripes of the first material at a depth less than the depth of second material applied over the first face of the carrier medium that is not covered by stripes of first material.

Alternatively, the second material may be applied such that the substrate formed by the first material and second material is not of a substantially constant depth. For example, the second material may be applied such that a surface of the substrate is provided with projections such as ridges or ledges, which may be regularly or irregularly spaced.

The depth of the substrate formed by the first material and second material may be any suitable depth in view of the intended application. It is suitably 1 mm or more, such as 1.5 mm or more, preferably 2 mm or more, for example 3 mm or more.

The surface of the substrate may, in one embodiment, comprises 30% or more non-tacky material, such as 40% or more, e.g. 50% or more. Preferably the surface of the substrate comprises more non-tacky material than tacky material. For example, there may be 60% or more of the surface of the substrate that is non-tacky material, such as 65% or more, 70% or more, 75% or more, e.g. 80% or more.

In step (d) the substrate is cut (directly or indirectly) into strips of a width corresponding to the width of the spacers being produced. This width may be from 2 mm to 100 mm, for example from 5 mm to 50 mm, such as from 10 mm to 40 mm, preferably from 12 mm to 30 mm, more preferably from 15 mm to 25 mm, such as from 16 mm to 20 mm, for example from 17 mm to 18 mm.

In step (d) the substrate is suitably cut into strips along its length.

The cutting into strips carried out in step (d) may be carried out using any suitable cutting means, for example a knife, such as a cutting knife. The cutting may suitably be carried out in a flat bed press or a rotary cutting press or other such suitable means.

The cutting into strips carried out in step (d) may suitably cut through the first and second material and leave the carrier medium intact or partially intact. Alternatively this cutting step may cut through the first and second material and the carrier medium.

In one embodiment the method may further include the step of:

(e) cutting the substrate formed by the first and second materials into spacer sized lengths.

In step (e) the substrate may be directly cut into spacer sized lengths, or the substrate may firstly be cut into strips having a greater length, which are subsequently cut into spacer sized lengths.

In step (e) the substrate is suitably cut into spacer sized lengths across its width.

This step may be carried out before, during or after step (d); in other words the substrate formed by the first and second materials may be cut into spacer sized lengths before cutting the product into a plurality of strips, or the substrate formed by the first and second materials may be cut into a plurality of strips before cutting these strips into spacer sized lengths, or both steps may occur together.

The method of the first aspect may optionally include the step of curing the first material after it has been applied to the carrier medium in step (b) and before the layer of the second material is applied in step (c). The curing step may involve curing some or all of the material. Essentially, it is preferred that sufficient curing of the first material is carried out such that when the second material is applied over the first material this does not disrupt the first material.

In one embodiment, however, the layer of the second material is applied over the first face of the carrier medium in step (c) without the first material having been cured. Surprisingly, when the first material is applied as stripes the second material may be able to be applied over uncured first material without disrupting the first material.

The method may also optionally include the step of curing the second material after it has been applied to the carrier medium in step (c).

The method may alternatively include the step of curing both the first material and the second material after the second material has been applied to the carrier medium in step (c).

The method may suitably include the step of heating the product after the layer of the second material has been applied in step (c). This step is suitably carried out before step (d) and/or step (e). This heating step may suitably be carried out by placing the product into one or more ovens.

The heating may be at any appropriate temperature, but may suitably be at a temperature of from 100 to 250° C., for example from 125 to 230° C., such as from 175 to 225° C., preferably from 190 to 210° C., for example about 200° C. If more than one oven is used the temperature in each oven may be the same or different. The heating step may be for any suitable length of time but may, for example, be from 1 minute to 3 minutes, preferably from 1 minute to 2.5 minutes, for example 1.5 minutes or 2 minutes.

Suitably in step (b) the carrier medium may advance through an applying section as the stripes of the first material are applied. Preferably the stripes of the first material are applied parallel to the direction of advancement of the carrier medium through this applying section.

In methods whereby the second material applied in step (c) does not cover the stripes of first material, the method may optionally include the further step of treating the tacky material on one face of the substrate formed by the first and second materials such that it becomes substantially non-tacky. For example, the tacky material may be heat treated, such as by singeing, or chemically treated, so as to render it substantially non-tacky. The treatment may also be carried out through the carrier medium, for example by electron beam treatment through the carrier medium.

By carrying out such a step the resultant spacer only has one face provided with stripes of tacky material, which can be used to hold the spacer in place, which assists in the handling of the product.

Preferably, the tacky material is not a pressure sensitive adhesive.

The tacky material may comprise a polymer, such as PVC or polyurethane or polyethylene. The tacky material may in particular be a plastic material.

Suitably, the tacky material may be a plastic composite, such as a PVC composite or polyurethane composite or polyethylene composite, which has tacky properties. A composite is a material made from two or more constituent materials that remain separate and distinct on a macroscopic level while forming a single component.

The tacky material may be an expanded or expandable material. The tacky material may suitably be a foamed or foamable material.

The tacky material may be a plastic material that comprises resin and plasticiser in an amount in excess of the amount needed to soften the resin. In one embodiment, the tacky material is a plastic composite that comprises resin and plasticiser in an amount in excess of the amount needed to soften the resin.

In this case the excess plasticiser acts to make the plastic material or composite tacky. The exact amount of excess plasticiser is selected in view of the nature of the plasticiser and the other components present, and the desired tackiness of the product.

The resin may be any suitable resin, and may be a natural resin or a synthetic resin. The resin may be a single resin or a mixture of two or more resins. The resin may, for example, be a PVC resin or polyurethane resin or polyethylene resin. The resin is suitably a foamable resin and is preferably a homopolymer.

Suitably 50 wt % or more of the resin is a dispersion resin (i.e. a resin that has been prepared by emulsion (dispersion) polymerisation), such as 60 wt % or more, preferably 70 wt % or more, more preferably 75 wt % or more, most preferably 80 wt % or more, such as 90 wt % or more, for example 100 wt %. The resin is preferably a dispersion resin having a K value (as measured by ISO 1628-2) of from 60 to 75, preferably from 65 to 70, for example 68. The resin is preferably a resin having a viscosity (as measured by ISO 2555) of from 90 to 140 cm³/g, preferably from 110 to 120 cm³/g, such as from 115 to 118, for example 116.

When the resin is a PVC resin it may be a vinyl chloride homopolymer, a copolymer of 50 wt % or more vinyl chloride with one or more monomers that are copolymerisable with vinyl chloride (such as vinyl acetate), or mixtures thereof. In one embodiment, the resin is a PVC paste. The resin may be a paste-making vinyl chloride homopolymer.

The plasticiser may be any plasticiser compatible with the resin used and may be a single plasticiser or a mixture of two or more plasticisers. A plasticiser that comprises two or more plasticisers is preferred, in particular a plasticiser that comprises two or more different types of plasticiser.

The plasticiser may be selected from phthalate esters, such as di-n-butyl phthalate, di-n-octyl phthalate, di-2-ethylhexyl phthalate (DOP), diisooctyl phthalate, octyldecyl phthalate, diisononyl phthalate (DINP), diisodecyl phthalate, butylbenzyl phthalate, octylbenzyl phthalate, and di-2-ethylhexyl isophthalate; tri metallic acid plasticisers, such as trioctyl mellitate and triisodecyl trimellitate; fatty acid plasticisers, such as di-2-ethylhexyl adipate (DOA), di-n-decyl adipate, di-isodecyl adipate, di-2-ethylhexyl azelate, dibutyl sebacate and di-2-ethylhexyl sebacate; phosphioric acid esters, such as tricresyl phosphate and octyl diphenyl phosphate; polymeric plasticisers, in particular polyester plasticisers, such as polyester plasticisers having a molecular weight of from 600 to 8000 obtained from a dibasic acid and glycol; epoxy plasticisers, such as epoxydised soybean oil (ESBO) and epoxydised tall oil 2-ethylhexyl fatty acid; and mixtures thereof.

Suitably the plasticiser may comprise a phthalate based compound; a phthalate based compound having a chain of from 7 to 9 carbon atoms, such as 8 carbon atoms, is preferred; for example DOP.

Suitably, the plasticiser comprises a polyester plasticiser, such as a polyester plasticiser having a molecular weight of from 250 to 10000, preferably from 600 to 8000, obtained from a dibasic acid and glycol. The polyester plasticiser suitably has a viscosity (as measured by ASTM D-1545 at 25° C., TBR) of from 30 to 45, preferably from 31 to 40, such as from 34 to 36.

In one embodiment the plasticiser comprises both a phthalate based compound and a polyester plasticiser. It is preferred that it is the polyester plasticiser that is present in excess, such that the amount of plasticiser is greater than that required to soften the resin. The plasticiser may, for example, comprise from 10 wt % to 30 wt %, such as from 15 wt % to 20 wt %, phthalate based compound, based on the total weight of plasticiser, and may comprise from 70 wt % to 90 wt %, such as from 80 wt % to 85 wt %, polyester plasticiser, based on the total weight of plasticiser.

The total amount of plasticiser may be any suitable amount provided that it is more than the amount required to soften the resin. The plasticiser may suitably be present in an amount of from 80 to 200 parts by weight per 100 parts of resin, preferably from 100 to 190 parts, more preferably from 130 to 180 parts, such as from 150 to 160 parts.

Optionally, part of the plasticiser may be substituted by a diluent or organic solvent capable of swelling the resin. The diluents and solvents may, for example, be toluene, xylene, hexanol isobutylate or dodecylbenzene. Other solvents that may be mentioned include volatile aliphatic and naphthenic hydrocarbons, such as mineral sprits; VM&P naphthas and aromatic hydrocarbons, such as ethylbenzene, xylene, chlorobenzene; halogenated hydrocarbons, such as ethylene chloride, trichloroethane, carbon tetrachloride; ketones, such as acetone, methylethylketone, methylisobutylketone; and dispersant esters such as n-butyl acetate, ethylene glycol, mono-n-butyl ether. The amount of plasticiser substituted by a diluent or organic solvent is determined by the intended purpose and the quality of the solvent. However, the solvent/diluent content may suitably be 80 wt % or less of the plastic material or composite, and it is preferred that the solvent/diluent content is 10 wt % or less of the plastic material or composite, more preferably 5 wt % or less of the composite, for example from 3 to 5 wt %.

The plastic material or composite preferably further comprises blowing agent. The blowing agent may be any complex organic compound that, on being heated, decomposes with release of nitrogen. Clearly, it is also preferred that in the event the blowing agent leaves any residues, these residues are compatible with the remaining components of the plastic material or composite. The blowing agent may be a single agent or a mixture of two or more agents. Preferably the blowing agent decomposes within a narrow temperature range, which assists in obtaining a good cell structure in the substrate.

The blowing agent may suitably be an azo compound, a sulphonhydrazide or a sulphoncarbazide. Blowing agents that may in particular be mentioned are azodicarbonamide, azobisisobutyronitrile, barium azodicarboxylate, p,p′-oxybis(benzenesulphonyl hydrazide) and p,p′-oxybis(benzenesulphonyl semicarbazide), and mixtures thereof. The use of azodicarbonamide or azobisisobutyronitrile is preferred, with azodicarbonamide being most preferred.

The amount of blowing agent is selected in view of the desired degree of expansion of the plastic material or composite. Suitably, the blowing agent may be included in an amount of from 0.1 to 20 parts by weight per 100 parts of resin, preferably from 0.5 to 5 parts, more preferably from 1 to 3 parts, such as from 1.5 to 2.5 parts, for example 2 parts.

The plastic material or composite optionally further comprises stabiliser that lowers the decomposition temperature of the blowing agent and reduces the decomposition of the resin under the effect of heat and/or light. The stabiliser may be a single stabilising agent or a mixture of two or more stabilising agents. If the blowing agent is a co-activated grade of blowing agent it will confer sufficient processing heat stability and therefore a stabiliser serves no useful purpose and should preferably not be included.

The stabiliser may be selected from amines, amides, urea, sulphonhydrazides, metal salts, metal oxides, metal soaps, phosphites, antioxidants, light stabilisers, epoxy compounds, and mixtures thereof.

The amines or amides may suitably have from 1 to 10 carbon atoms. The metal salts, metal oxides and metal soaps may suitably be salts, oxides or soaps of one or more of zinc, barium, sodium, potassium, calcium, magnesium, lithium, cadmium, lead and tin. The metal salts may be salts of inorganic or organic acids or phenols, and may suitably be mineral acid salts such as phosphates, sulphates or carbonates. The metal soaps may be derived from fatty acids such as 2-hexylhexanoic acid, linoleic acid, behenic acid, isostearic acid, oleic acid, and ricinoleic acid, and may be composite metal soaps such as Ca/Zn or Ba/Zn composite soaps.

The antioxidants may be of the phenol, thioether or phosphorus type. The light stabilisers may be of the diketo, salicylic acid, benzophenone, benzotriazole, or hindered amine type. The stabiliser may, for example, comprise a UV light stabiliser, which may suitably be selected from substituted benzophenones, such as 4-decyl-2-hydroxy-benzophenone, 2-hydroxy-4-dodecyloxy-benzophenone, and 2-hydroxy-4-N-octoxy-benzophenone, and mixtures thereof.

The stabiliser may in particular comprise a metal containing compound. In one embodiment, the stabiliser is a zinc salt, such as zinc nitrate, zinc sulphate or zinc chloride.

The amount of stabiliser used, when present, is selected in view of the desired degree of stabilisation required for the blowing agent. Suitably, the stabiliser may be included in an amount of from 0.1 to 5 parts by weight per 100 parts of resin, preferably from 0.5 to 4 parts, more preferably from 1 to 3 parts, for example 2 parts.

The plastic material or composite optionally comprises secondary heat stabiliser. The secondary heat stabiliser may be a single stabilising agent or a mixture of two or more stabilising agents.

The secondary heat stabilising agent is suitably selected from epoxidized and esterified fatty acids, such as epoxidized or esterified linoleic or stearic acid. Preferably, the secondary heat stabilising agent is epoxidized linoleic acid oil, such as epoxidized soybean oil (ESBO) or derivatives thereof, for example an acrylate of epoxidized soybean oil.

The amount of secondary heat stabiliser used, when present, is selected in view of the desired degree of stabilisation required. Suitably, the secondary heat stabiliser may be included in an amount of from 0.5 to 10 parts by weight per 100 parts of resin, preferably from 1 to 5 parts, more preferably from 2 to 4 parts, such as from 2.5 to 3.5 parts, for example 3 parts.

The plastic material or composite may optionally further comprise cell uniformalizing agent. The cell uniformalizing agent may be a single agent or a mixture of two or more agents. The agent may suitably be selected from acrylic resins, such as methyl(methacrylate) resin, methyl (methacrylate)/styrene copolymer resin, methyl(methacrylate)/butyl (methyacrylate) copolymer resin, and mixtures thereof.

The cell uniformalizing agent, when present, may be included in an amount of from 0.1 to 5 parts by weight per 100 parts of resin, for example from 1 to 3 parts.

The plastic material or composite may optionally further comprise thickener. The thickener may be a single thickening component or a mixture of two or more thickening components. The thickener may suitably be selected from fumed and precipitated silicas, calcium sulfonate-calcium carbonate complexes, clays, such as bentonite, metallic stearates, polyacrylic acid polymers, ultrafine calcium carbonates, and mixtures thereof.

The thickener, when present, may be included in an amount of from 0.25 to 25 parts by weight per 100 parts of resin, preferably 0.5 to 5 parts, more preferably from 0.75 to 3 parts, such as from 1 to 2 parts, for example 1.5 parts.

The plastic material or composite may optionally further comprise filler. The filler may be a single filling component or a mixture of two or more filling components. The filler may be coated or uncoated. The filler may suitably be selected from carbonates, sulfates, silicates, phosphates, borates, oxides and hydroxides of calcium, magnesium, aluminium, titanium, iron and zinc; silica; silicates; talcs, including anhydride talc; clays, including bentonite; corks; ceramic/glass micro spheres and fibres; powders, including glass powders such as borate glass powders, silicate glass powders and phosphate glass powders; woods, including sawdust; flours, including nut shell flours; and recycled plastics or foams including recycled PVC pieces; and mixtures thereof. The filler may in particular be calcium carbonate.

The filler may have any particle size but suitably has a particle size ranging from nanoparticles to 250 microns, preferably from 0.05 microns to 100 microns, for example from 2 to 70 microns, such as from 3 to 30 microns. The filler may be included in amounts of from 0 to 100 parts by weight per 100 parts resin, such as from 0 to 60 parts, preferably from 0 to 50 parts, more preferably from 5 to 30 parts, for example from 10 to 25 parts.

The plastic material or composite, in addition, may comprise reinforcing fibres, such as glass fibres, asbestos carbon fibres, boron fibres, metallic fibres and the like, which may enhance the mechanical properties of the end product.

The plastic material or composite may optionally further comprise viscosity depressant. The depressant may be a single viscosity depressant or a mixture of two or more viscosity depressants. The viscosity depressant may suitably be selected from non-ionic surfactants, such as ethoxylates of monohydric alcohols, alkylphenols and fatty acids; anionic surfactants, such as sulfosuccinates, including sodium dioctyl sulfosuccinate and sodium ditridecyl succinate; soybean lecithin; silicones; monohydric alcohols; glycol ethers; and polyethylene glycols; and mixtures thereof.

The viscosity depressant, when present, may suitably be present at a level of 10 wt % or less, based on the total composite, for example 2 wt % or less.

The plastic material or composite may optionally further comprise flame/smoke retardant. The flame/smoke retardant may be a single flame/smoke retardant or a mixture of two or more flame/smoke retardants. The flame/smoke retardant may suitably be selected from organic flame/smoke retardants, such as plasticiser as described above; and inorganic flame/smoke retardants. Inorganic flame/smoke retardants include antimony compounds and derivatives thereof, such as antimony trioxide, antimony pentoxide, and sodium antimonite; metal hydroxides, hydrocarbonates and carbonates, such as alumina trihydrate and alkaline earth metal derivatives thereof, aluminium trihydrate, and magnesium hydroxides, hydrocarbonates and carbonates; and molybdenum, zinc and iron compounds; and mixtures thereof.

The plastic material or composite may optionally further comprise pigment. The pigment may be a single pigment or a mixture of two or more pigments. Any pigment may be used, in particular pigments known for use in plastic composites such as foamable plastic composites. The pigment, when present, may be included in any suitable amount to achieve the desired level of colour in the product. The pigment may, for example, be included at a level of from 0 to 2 parts by weight per 100 parts of resin, such as from 0.5 to 1 parts, for example 0.6 to 0.8 parts.

Any other conventional additives known for inclusion in plastic materials or composites, such as foamable plastic composites, may also be included at any suitable level in the plastic material or composite.

Alternatively, the tacky material may be a plastic material comprising resin and plasticiser and tackifier. In particular, in an alternative embodiment, the tacky material is a plastic composite comprising resin and plasticiser and tackifier. The tackifier may suitably be included in the plasticiser, or may be added to the composite mixture.

The plastic material or composite may comprise resin, plasticiser and optional other components as described above. It is preferred that the plastic material or composite comprises only an amount of plasticiser sufficient to soften the resin rather than an excess; although in one embodiment the plasticiser is present in an excess, as described above, such that this excess plasticiser itself acts to make the composite tacky.

The plasticiser is preferably a single plasticiser, although it may also be a mixture of two or more plasticisers. The composite may suitably comprise plasticiser in an amount of from 20 to 100 parts by weight per 100 parts of resin, preferably from 30 to 90 parts, more preferably from 40 to 80 parts, for example from 45 to 55 parts, more preferably from 50 to 80 parts, such as from 50 to 60 parts.

The tackifier may be any product or combination of products with tackifier properties. In particular the tackifier may be one or more conventionally known tackifiers. The tackifier may suitably be selected from acetates, acrylates, gum resins, polysaccharide gums, rosins and derivatives thereof, alkyl and aryl hydrocarbon resins and derivatives thereof, petroleum-aliphatic resins, terpene resins, and mixtures thereof.

Tackifiers that may in particular be mentioned include emulsified rosins, partially decarboxylated rosins, glycerol esters of polymerised rosins, partially dimerised rosins, hydrogenated wood rosins, plasticised hydrogenated rosins, rosin esters, natural resins, aliphatic hydrocarbon resins from petroleum, aromatic petroleum resins, terpene/phenol resins, cumarone/indene resins, polydicylopentadiene resins, EVA and pentaerythritol esters.

The tacky material may alternatively be a product that is inherently tacky. Examples of inherently tacky materials are the tackifiers listed above.

Clearly, the tacky material should be such that it can be applied in stripes, patterns or layers as needed.

The non-tacky material may comprise a polymer, such as PVC or polyurethane or polyethylene, provided that the material has properties such that it is relatively non-tacky and will not stick to the glass or other material to be separated. The non-tacky material may be a plastic material that has properties such that it is relatively non-tacky and will not stick to the glass or other material to be separated.

The non-tacky material may be a plastic composite, such as a PVC or polyurethane or polyethylene composite, that has properties such that it is relatively non-tacky and will not stick to the glass or other material to be separated. The non-tacky material may alternatively be a cork composite that has properties such that it is relatively non-tacky and will not stick to the glass or other material to be separated.

The non-tacky material may be a plastic material comprising resin and plasticiser and optional other components. The non-tacky material may in particular be a composite comprising resin and plasticiser and optional other components. This plastic material or composite may be as described above in relation to the tacky material but with the composite comprising only an amount of plasticiser sufficient to soften the resin. The plasticiser is preferably a single plasticiser, for example a phthalate based plasticiser, although it may also be a mixture of two or more plasticisers.

In this case the plasticiser may suitably be present in an amount of from 20 to 100 parts by weight per 100 parts of resin, preferably from 30 to 90 parts, more preferably from 40 to 80 parts, for example from 45 to 55 parts, more preferably from 50 to 80 parts, such as from 50 to 60 parts.

Clearly, the non-tacky material must be such that it can be applied in stripes, patterns or layers as needed.

The first material may be applied in stripes by any suitable method. Suitably, the first material may be applied in stripes by a die, for example by extrusion through a slot die, or by a grooved knife, or by printing, for example screen-printing.

The second material may be applied by any suitable method. Suitably, the second material may be applied by a knife, for example a knife may be used to smooth a layer of second material over the stripes of the first material and the carrier medium. Alternatively, the second material may be applied using a die or by printing, for example screen-printing. The carrier medium may be any medium having one or more layers that can support the first material and second material. In particular, the carrier medium may comprise any suitable sheet that can support the first material and second material. Suitably the carrier medium is able to support the substrate formed by the first material and second material as it passes through one or more ovens in one or more heating steps. In one embodiment the carrier medium is able to protect the substrate formed from the tacky material and non-tacky material and preferably is able to be easily released therefrom when required.

Release sheets, such as release papers or casting sheets commonly known in the art, may suitably be used as the carrier medium. For example the carrier medium may comprise silicone release paper or polyester casting sheet.

The carrier medium may alternatively comprise a belt, from which the substrate formed by the first material and second material can be released, for example after the substrate formed by the first material and second material has been heated in one or more ovens. The belt may be a metal, PTFE, PTFE coated, or silicon based, e.g. silicon rubber coated, belt. For example, the belt may be a PTFE coated glass fabric or a silicon rubber coated glass fabric.

At any stage in the method the substrate formed by the first material and second material can be released from the carrier medium. The substrate may then be left without a carrier medium or the substrate may be provided with a further carrier medium as required, which may be the same as or different to the previous carrier medium.

For example, the first carrier medium may be a belt and the substrate formed by the first material and second material can be released from this belt during the method of the first aspect. The substrate may be released from the belt, for example, after the substrate formed by the first material and second material has been heated in one or more ovens and before, during or after cutting the substrate in step (d) and step (e). The released substrate can then be provided with a further carrier medium, for example a release sheet, or can be left without a carrier medium, as required.

The method may optionally include the further step of rolling the formed product into a roll. Two or more of these rolls, such as three, four, five, six, seven, eight, nine, ten or more of these rolls, may combine together to form a master roll. This step may be carried out before, during or after step (d); and may be carried out before or after step (e). Clearly, if the step of rolling the formed product into a roll is carried out after steps (d) and (e), then some connection between the spacers that are cut must be maintained; for example the substrate may have been cut into spacers but a carrier medium may connect the spacers or integral bridges may have been left in when the substrate was cut in step (d) and/or step (e).

Accordingly, in one embodiment of the invention the method may include the step of providing the formed product with bridges between strips of material formed in step (d) and/or between spacer sized lengths formed in step (e).

The bridges may be formed in the substrate formed from the first and second materials, or in the carrier medium, or in both the substrate formed from the first and second materials and the carrier medium.

When a master roll is formed, the method may include the step of providing the formed product with bridges between adjacent rolls in the master roll. Each bridge may be a continuous or substantially continuous join between the rolls, which is sufficiently thin that it is broken by the unwinding force as one or more roll is unwound from the master roll.

By substantially continuous it is meant that there are relatively few gaps in the join, for example 95% or more of the join is continuous, such as 98% or more, e.g. 99% or more. Creating gaps in the bridges could cause minor damage to the carrier medium, when present, making it difficult to reuse. In contrast, a continuous or substantially continuous join could be made without the cutting tool actually contacting the carrier medium, when present, thereby aiding multiple use of the carrier medium.

The bridges may be any size and shape provided that they act to support the strips of material formed in step (d) or the spacer sized lengths formed in step (e) when rolled in a roll or master roll. Preferably, the bridges are such that they break as a strip is unwound from a roll or master roll and/or as a spacer-sized length is pulled from a strip of spacer-sized lengths. When the bridges are present within a master roll, preferably the bridges break when one or more roll is unwound from the master roll, due to the unwinding force.

Preferably, the bridges have a width of from 0.1 mm to 5 mm, such as from 0.2 mm to 4 mm, more preferably from 0.3 mm to 3 mm, most preferably from 0.4 mm to 2 mm, such as from 0.5 mm to 1 mm, for example about 0.75 mm.

Preferably, the bridges have a thickness of from 0.1 mm to 5 mm, such as from 0.1 mm to 3 mm, more preferably from 0.2 mm to 2 mm, most preferably from 0.3 mm to 1 mm, such as from 0.4 mm to 0.8 mm, for example about 0.5 mm.

Preferably, the bridges are spaced apart by a distance of from 1 mm to 250 mm, such as from 1.5 mm to 100 mm, more preferably from 2 mm to 50 mm, most preferably from 3 mm to 10 mm, such as from 4 mm to 8 mm, for example about 5 mm.

In one embodiment, two or more rolls are combined in a master roll and the pulling force of unwinding one or more roll from the master roll is used to break the bridges. In this embodiment, the strength of the bridges is therefore less than the unwinding force. Each bridge may suitably have a strength of 90% or less of the unwinding force, such as 80% or less, 70% or less, 60% or less, 50% or less, 40% or less, 30% or less, 20% or less, 10% or less, 5% or less, 2% or less, or 1% or less of the unwinding force.

When measuring the break force of individual bridges using an Instron machine fitted with a 1000N head and operated at a speed of 300 mm per minute, each bridge may suitably have a break force of from 1 to 100N, preferably from 2 to 75N, such as from 3 to 50N, for example from 4 to 25 N, more preferably from 5 to 10N, such as from 1 to 5N, for example from 1.5 to 2.5N.

The bridges may be formed at any suitable stage in the method. The bridges may be formed on the same machine as the product is formed or on a different machine.

In one embodiment, the bridges may be formed before, during or after the substrate formed from the first and second materials has cooled following heating; for example the substrate formed from the first and second materials may have been heated in one or more oven and then the bridges may be formed immediately after the substrate has left the oven, whilst the substrate cools following its exit from the oven, or after the substrate has cooled following its exit from the oven.

In one embodiment, the bridges may be formed before, during or after the substrate formed from the first and second materials is released from the carrier medium; for example the bridges may be formed before the substrate is released from the carrier medium, whilst the substrate is released from the carrier medium, or after the substrate has been released from the carrier medium.

In one embodiment, the bridges may be formed prior to or after rolling the substrate into a roll.

When rolled, the product may be provided in various lengths and widths as necessary to ease its use with specialist application equipment or by hand. Where such equipment is used, the dispensers themselves may serve to cut the spacers at the required size and/or apply them to the glass and or other materials.

If when step (e) is carried out there is a carrier medium present, this cutting of the substrate into spacer sized lengths may suitably cut through the first and second material and leave the carrier medium intact or partially intact. Alternatively this cutting step may cut through the first and second material and the carrier medium.

Suitably a carrier medium is present at the time of step (e) and this medium is a release sheet. Preferably step (e) cuts through the first and second material and partly cuts the release sheet providing a construction that allows lengths of product to easily be removed from a roll.

This partial cutting may comprise providing a cut at either side of the release sheet. Alternatively, it may comprise providing perforations or cuts across the width of the release sheet, or in the machine direction, or both across the width of the release sheet and in the machine direction. Suitably, the optional cutting step (e) may be carried out by methods as described in British patent publication GB-A-2 375 729. The optional cutting step may suitably cut the product into lengths of from 2 mm to 100 mm, for example from 5 mm to 50 mm, such as from 10 mm to 40 mm, preferably from 12 mm to 30 mm, more preferably from 15 mm to 25 mm, such as from 16 mm to 20 mm, for example from 17 mm to 18 mm.

In an alternative first aspect of the invention there is provided a method of manufacturing a plurality of spacers comprising:
(i) providing a carrier medium; and
(ii) applying a tacky material on a first face of the carrier medium; so as to form a substrate on the carrier medium comprising tacky material; and then
(iii) treating sections of the surface of the tacky material such that it becomes substantially non-tacky in these sections, so as to create a surface provided with stripes of tacky material interspaced with stripes of non-tacky material;
   wherein the tacky material is material that, in the end spacer product at room temperature, is a tacky material that will readily hold the spacer in place during its intended use, and the non-tacky material is material that, in the end spacer product at room temperature, is a non-tacky material that will substantially not stick to the glass or other material to be separated;
   and wherein the stripes of tacky material thus produced are spaced apart such that when the substrate formed by the tacky and non-tacky material is cut into strips of a width corresponding to the width of the spacers being produced, one or more of the cut edges of each strip includes a portion of non-tacky material.

In step (iii) the sections of tacky material may, for example, be heat treated, such as by singeing, or chemically treated, so as to render it substantially non-tacky. The treatment in step (iii) may also be irradiation treatment, e.g., electron beam treatment, or light treatment, e.g. UV or infrared treatment. A combination of one or more treatments may also be used.

The chemical treatment may be applied directly to the tacky material or may be applied indirectly, for example by applying the treatment to a carrier medium that subsequently contacts the tacky material. The treatment may also be carried out through the carrier medium, for example by electron beam treatment through the carrier medium.

By carrying out such a step the resultant spacer has a face provided with stripes of tacky material, which can be used to hold the spacer in place, and stripes of non-tacky material, which can be used to remove the spacer when it is no longer required.

The method is relatively simple and straightforward, involving a small number of steps and not requiring transfer between factories.

Optionally, the method may also comprise the step of applying a layer of non-tacky material. In this case the non-tacky material may be applied before or after the tacky material, and, if it is applied after, it may be carried out before, during or after step (iii).

The non-tacky material may be provided adjacent the tacky material, either above the tacky material, such that the tacky material is between the non-tacky material and the carrier medium, or between the tacky material and the first face of the carrier medium. Alternatively, it may be provided on a second face of the carrier medium, such that the carrier medium is between the tacky material and non-tacky material.

In one embodiment, the method comprises applying the layer of non-tacky material on a first face of the carrier medium and then applying tacky material over this non-tacky material. In another embodiment, the method comprises applying tacky material on a first face of the carrier medium and applying the layer of non-tacky material on a second face of the carrier medium (these applications of material may be simultaneous or in either order). In another embodiment, the method comprises applying the tacky material on a first face of the carrier medium and then applying the layer of non-tacky material over this tacky material.

Alternatively, the method may optionally comprise the step of treating one surface of the tacky material such that it becomes substantially non-tacky, so as to create a non-tacky layer at one surface. This step may be carried out before or after step (iii). This treatment step may be by any of the methods referred to above in relation to step (iii).

The one or more stripes of tacky material created in step (iii) may each independently be of a size and shape as described above.

Preferably each spacer generated has an edge portion with non-tacky material but a degree of wastage is acceptable.

The layer of tacky material may be any suitable depth in view of the intended application. Suitably, the tacky material may be of a depth as described above in relation to the stripes of the first material.

When present, the layer of non-tacky material may be any suitable depth in view of the intended application. Suitably, the non-tacky material may be of a depth as described above in relation to the second material.

In the event that the tacky and/or non-tacky material is expandable, e.g. foamable, material, it may be applied in a depth less than the intended depth and then expanded, e.g. foamed, such that the intended depth is achieved.

The depth of the substrate that is formed by the tacky material and non-tacky material may be any suitable depth in view of the intended application. It is suitably 1 mm or more, such as 1.5 mm or more, preferably 2 mm or more, for example 3 mm or more.

Optional step (d) may be included as described above.

Optional step (e) may be included as described above.

Bridges may be formed in the product, as described above.

The tacky layer may, optionally, be cured after it has been applied to the carrier medium in step (ii) and before the treatment step (iii). In the event that a layer of non-tacky material is applied, the method may also optionally include the step of curing the non-tacky material after it has been applied.

Equally, if a layer of non-tacky material is applied, the method may alternatively include the step of curing both the tacky material and the non-tacky material after both materials have been applied.

A step of heating the product may also preferably be carried out, as described above. This step may be carried out before, during or after step (iii).

The tacky and non-tacky materials are as described above.

The tacky material and, when applied, the non-tacky material, may each independently be applied by any suitable method. Suitably, the materials may each be applied by a knife. Alternatively, the materials may be applied using a die or by printing, for example screen-printing.

The carrier medium may be as described above.

At any stage in the method the substrate can be released from the carrier medium, as described above.

The method may optionally include the further step of rolling the formed product into a roll, as described above. The product that is rolled may of course be with or without a carrier medium.

In a further alternative first aspect of the invention there is provided a method of manufacturing a plurality of spacers comprising:
(i) providing a carrier medium; and
(ii) applying a substantially non-tacky material on a first face of the carrier medium; so as to form a substrate on the carrier medium comprising non-tacky material; and then
(iii) treating sections of the surface of the non-tacky material such that it becomes substantially tacky in these sections, so as to create a surface provided with stripes of tacky material interspaced with stripes of non-tacky material;
   wherein the tacky material is material that, in the end spacer product at room temperature, is a tacky material that will readily hold the spacer in place during its intended use, and the non-tacky material is material that, in the end spacer product at room temperature, is a non-tacky material that will substantially not stick to the glass or other material to be separated;
   and wherein the stripes of tacky material thus produced are spaced apart such that when the substrate formed by the tacky and non-tacky material is cut into strips of a width corresponding to the width of the spacers being produced, one or more of the cut edges of each strip includes a portion of non-tacky material.

In step (iii) the sections of non-tacky material may, for example, be heat treated or chemically treated so as to render it tacky. The treatment in step (iii) may also be irradiation treatment, e.g., electron beam treatment, or light treatment, e.g. UV or infrared treatment. A combination of one or more treatments may also be used.

The chemical treatment may be applied directly to the non-tacky material or may be applied indirectly, for example by applying the treatment to a carrier medium that subsequently contacts the non-tacky material. The treatment may also be carried out through the carrier medium, for example by electron beam treatment through the carrier medium.

By carrying out such a step the resultant spacer has a face provided with stripes of tacky material, which can be used to hold the spacer in place, and stripes of non-tacky material, which can be used to remove the spacer when it is no longer required.

The method is relatively simple and straightforward, involving a small number of steps and not requiring transfer between factories.

The one or more stripes of non-tacky material created in step (iii) may each independently be of a size and shape as described above.

Preferably each spacer generated has an edge portion with non-tacky material but a degree of wastage is acceptable.

The layer of tacky material obtained by this method may be any suitable depth in view of the intended application. Suitably, the tacky material may be of a depth as described above in relation to the stripes of the first material.

The layer of non-tacky material may be any suitable depth in view of the intended application. Suitably, the non-tacky material may be of a depth as described above in relation to the stripes of the second material.

In the event that the tacky and/or non-tacky material is expandable, e.g. foamable, material, it may be applied in a depth less than the intended depth and then expanded, e.g. foamed, such that the intended depth is achieved.

The depth of the substrate that is formed by the tacky material and non-tacky material may be any suitable depth in view of the intended application. It is suitably 1 mm or more, such as 1.5 mm or more, preferably 2 mm or more, for example 3 mm or more.

Optional step (d) may be included as described above.

Optional step (e) may be included as described above.

Bridges may be formed in the product, as described above.

The non-tacky layer may, optionally, be cured after it has been applied to the carrier medium in step (ii) and before the treatment step (iii).

A step of heating the product may also preferably be carried out, as described above. This step may be carried out before, during or after step (iii).

The tacky and non-tacky materials are as described above.

The non-tacky material may be applied by any suitable method. Suitably, the material may be applied by a knife. Alternatively, the material may be applied using a die or by printing, for example screen-printing.

The carrier medium may be as described above.

At any stage in the method the substrate can be released from the carrier medium, as described above.

The method may optionally include the further step of rolling the formed product into a roll, as described above. The product that is rolled may of course be with or without a carrier medium.

By using a method as provided in the first aspect, advantageous spacers can be produced, as the tacky material acts to hold the spacer in position to avoid the spacer falling off, whilst a fingerlift function is achieved as a non-tacky edge is provided which permits easy removal of the spacer when required.

Accordingly, the present invention further provides a spacer obtained by a method of the first aspect.

In a second aspect the invention provides a spacer, suitable for spacing sheets of glass, comprising a pad element that has a first portion made of a tacky material, such that in use at room temperature the face or faces of the pad element that comprise this tacky material that contact a material to be spaced adhere to said tacky material, and a second portion made of a substantially non-tacky material, such that in use at room temperature the face or faces of the pad element that comprise this non-tacky material that contact a material to be spaced do not adhere to said material, wherein at least part of the first portion is located at a face of the pad element, at least part of the second portion is located at an edge of the pad element and wherein the pad element is sufficiently flexible that the second portion can be bent out of a plane which the first portion occupies so that during removal of the pad element from said material said second portion is finger liftable relative to the material to which said first portion is adhered when in use.

In this way a finger or other means employed to remove the spacer can easily do so as a portion of the edge is easily liftable relative to the spaced element.

Preferably the tacky material is provided in one or more stripes. An easy manner for introducing the tacky material is thus allowed. These stripes may suitably be of dimensions as discussed above in relation to the stripes of first material of the first aspect. Most preferably the stripes are substantially perpendicular to an edge of the spacer. This gives regular positioning of the tacky material on a series of spacers.

The tacky material may be provided in a central portion of a face of the pad element, so providing a large amount of non tacky edge material. Alternatively, or additionally, the tacky material may follow one or more edges of the pad element, leaving one or more other edges or portions thereof as non tacky edge material.

The or each face of the pad element that comprises tacky material may, in one embodiment, comprise 30% or more substantially non-tacky material, such as 40% or more, e.g. 50% or more. Preferably or each face of the pad element that comprises tacky material comprises more of the non-tacky material than the tacky material. For example, there may be 60% or more of the face of the pad element that is substantially non-tacky material, such as 65% or more, 70% or more, 75% or more, e.g. 80% or more.

The tacky material may be provided in a continuous or discontinuous layer. Thus the tacky material may be provided as dots, dashes, cross-hatching or the like to give the desired degree of adhesion.

The tacky material is preferably a tacky material as described above in relation to the first aspect.

The non-tacky material is preferably a non-tacky material as described above in relation to the first aspect.

The tacky material may be present in any suitable depth in view of the intended application. Suitably, the tacky material may have a depth of 3 mm or less, such as 2 mm or less, preferably 1 mm or less, for example 0.5 mm, such as 0.25 mm or less. For example, the tacky material may have a depth of from 0.1 mm to 1 mm, such as from 0.25 mm to 0.75 mm.

The tacky material may have a depth less than or equal to the depth of the pad element. The tacky material may have a depth of three quarters or less of the depth of the pad element, for example a depth of half or less of the depth of the pad element, such as a depth of a third of the depth of the pad element. For example, the tacky material may have a depth of from one quarter to three quarters of the depth of the pad element, e.g. from one quarter to a half of the depth of the pad element, such as from one third to a half of the depth of the pad element.

The non-tacky material may be any suitable depth in view of the intended application. Suitably, the non-tacky material may have a depth of 1 mm or more, e.g. 1 mm to 5 mm, preferably 1.5 mm or more, e.g. 1.5 mm to 4 mm, more preferably 2 mm or more, such as 2 mm to 3 mm, e.g. 2.5 mm to 3 mm, for example 3 mm.

The spacer optionally further comprises a carrier medium, such as a release sheet. This sheet may be as described above in relation to the first aspect. The release sheet suitably is provided on one face of the pad element. The release sheet preferably covers some, most, substantially all or all of the first portion made of tacky material that is located at the surface of the pad element.

The pad element suitably has a depth of 1 mm or more, such as 1.5 mm or more, preferably 2 mm or more, for example 3 mm or more.

In another embodiment of the present invention there is provided a stack of two or more sheets of glass (or other material) wherein each sheet is separated by one or more spacers according to the second aspect of the invention or obtained by the method of the first aspect of the invention.

The present invention further provides, in a third aspect, a method of winding long lengths of material, for example spacer material, into a roll, which method comprises:

(a) providing a length of material cut into two or more strips of a desired width along its length, with each strip being joined to the strip or strips directly adjacent to it by means of one or more bridges; and
(b) winding two or more of the strips of material into a roll.

Preferably the material provided in step (a) has been produced by the method of the first aspect of the present invention. Accordingly, a preferred embodiment of the method of the third aspect comprises:

(1) carrying out a method in accordance with the first aspect described above, including the optional step (d); and
(2) carrying out steps (a) and (b) of the method of the third aspect as described above.

Clearly, in step (1) the method should involve the production of bridges in the material, as described above.

Suitably the material provided in step (a) of the method of the third aspect may have a length of 10 m or more, preferably 50 m or more, more preferably 100 m or more, such as 150 m or more. For example the material provided in step (a) may have a length of 200 m or more, such as 300 m or more, for example 400m or more.

The total width of all of the strips of material wound into a roll in the method is suitably from 10 mm to 4 m or more, preferably from 250 mm to 3.5 m, for example from 500 mm to 3 m, such as from 1 m to 2 m.

Step (a) may preferably comprise the steps of:
(a-i) providing a length of material; and
(a-ii) cutting the material into strips of a desired width along its length.

The bridges may suitably be as described above.

The bridges joining adjacent strips of material are preferably integral bridges. Such bridges may in particular be present due to the strips not having been completely cut apart but rather having been cut so as to leave bridges of material between adjacent strips. The material may be provided on a carrier medium and in this case the bridges may be formed in the material only, in the carrier medium only, or in both the material and the carrier medium.

Alternatively, the bridges may be separate components that join a strip of material to an adjacent strip. In this case the bridges are suitably components that can releasably join a strip of material to an adjacent strip, and may be a carrying medium woven into or abutting the material.

The width of the strips of material provided in step (a) may suitably be from 2 mm to 100 mm, for example from 5 mm to 50 mm, such as from 10 mm to 40 mm, preferably from 12 mm to 30 mm, more preferably from 15 mm to 25 mm, such as from 16 mm to 20 mm, for example from 17 mm to 18 mm.

The invention also provides a roll of a length of material, wherein the material is cut into strips of a desired width along its length, with each strip being joined to the strip or strips directly adjacent to it by means of one or more bridges.

The roll may suitably be obtained by the method of the third aspect.

The preferred features of the roll are as in the third aspect.

The present invention also provides, in a fourth aspect, a method of producing a bobbin wound with material, which method comprises:

(a) providing a roll of material comprising strips of material, with each strip being wound into a roll and joined to the strip or strips directly adjacent to it by means of one or more bridges;
(b) unwinding a strip of material from the roll; and
(c) winding said strip onto a bobbin.

The pulling force of unwinding the roll in step (b) can be used to break the bridges, and/or bridges can be cut prior to the unwinding step (b).

Preferably, only a single strip of material is unwound at a time in step (b). However, in an alternative embodiment two or more strips of material are unwound at a time in step (b). For example, it could be that two strips are unwound from opposite ends of the roll at the same time or it could be that two adjacent strips are unwound at the same time. When two or more strips are unwound at the same time they may be used to make two or more bobbins (for example a corresponding number of bobbins to the number of strips being simultaneously unwound), or they may be used to make a single bobbin.

Optionally a stabilising strip may be provided if desired. Such a strip may give stability to the strips of material not being unwound in step (b). The method may involve providing one or more stabilising strips that extend across some or all of the strips of material that are not being unwound; the stabilising strip(s) may be releasably secured to each strip of material. The stabilising strip(s) may suitably be stapled to some or all of the strips of material not being unwound in step (b). The stabilising strip(s) may be any suitable material; for example a strip of polyester.

The stabilising strip(s) preferably extend over at least the strips of material furthest from the strip being unwound; for example the half of the roll furthest from the strip being unwound may be provided with stabilising strip(s).

Preferably the roll of material provided in step (a) has been produced by the method of the third aspect of the present invention. Accordingly, a preferred embodiment of the method of the fourth aspect comprises:

(1) carrying out a method in accordance with the third method described above; and
(2) carrying out steps (a) to (c) of the method of the fourth aspect as described above.

Embodiments of the invention will now be described, by way of example only, with reference to the drawings in which:—

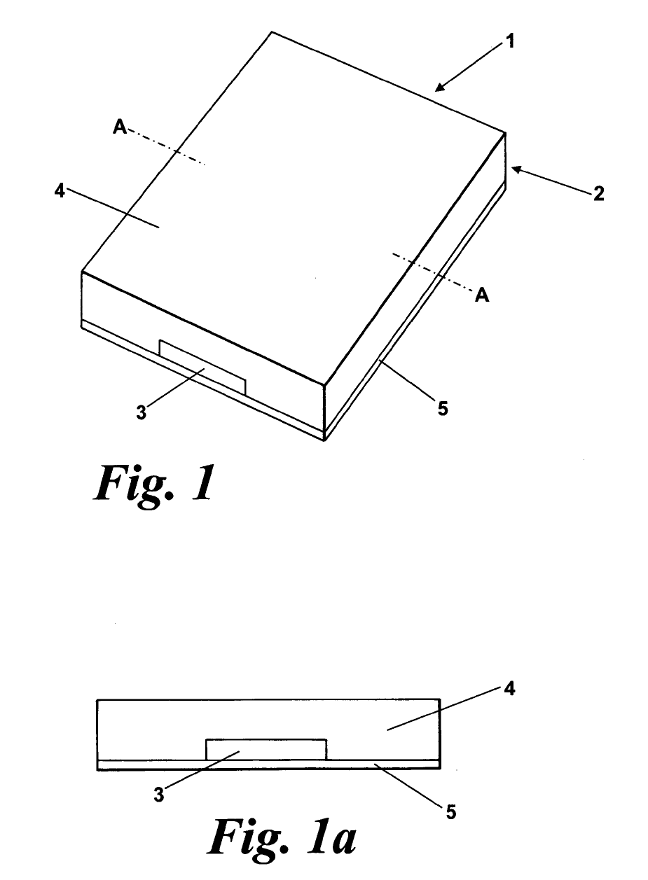

FIG. 1 shows a perspective view of a spacer in accordance with the second aspect of the present invention;

FIG. 1a shows a cross sectional view through the spacer along line A-A shown in FIG. 1; and

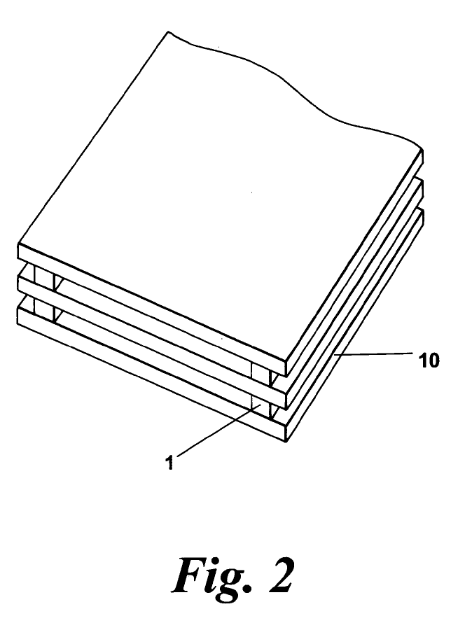

FIG. 2 shows a stack of sheets of glass separated by spacers according to the invention.

FIGS. 1 and 1a show a spacer 1, suitable for spacing sheets of glass. The spacer may suitably be produced by the method described below in the Examples.

The spacer comprises a pad element 2 that is substantially cuboid in shape, with a width of from 17 to 18 mm, a length of from 17 to 20 mm and a depth of from 2.5 to 3 mm. The pad element has a first portion made of a tacky material 3, such as a PVC composite comprising resin and an excess of plasticiser above the amount required to soften the resin, and a second portion made of a substantially non-tacky material 4, such as a non-tacky PVC composite comprising resin and plasticiser only in the amount required to soften the resin.

The tacky material is provided in a 0.5 mm deep stripe that runs along the length of the pad element at one of its 18 mm×20 mm rectangular faces, at the centre of this face. The non-tacky material makes up the remainder of the cuboid pad element.

The spacer also comprises a release paper 5, which is provided on the 18 mm×20 mm rectangular face of the pad element having the stripe of tacky material and covers this face.

The pad element is sufficiently flexible that the second portion can be bent out of a plane which the first portion occupies so that during removal of the pad element from said material said second portion is finger liftable relative to the material to which said first portion is adhered when in use. In this way a finger or other means employed to remove the spacer can easily do so as a portion of the edge is easily liftable relative to the spaced element.

FIG. 2 shows a stack of sheets of glass 10 wherein each sheet is separated by one or more spacers 1 as shown in FIG. 1.

### EXAMPLES

### Example 1a

A method of manufacturing a plurality of spacers in accordance with the present invention was carried out. The method firstly comprised the provision of a release sheet, such as a sheet of silicone release paper.

Then a plurality of stripes of a first, tacky material were applied to the release sheet. The tacky material was a plastic composite, such as a composite comprising PVC resin paste, phthalate plasticiser, polyester plasticiser, azo blowing agent, pigment and ESBO, with an excess of the polyester plasticiser such that the composite was tacky. The tacky material was applied in continuous stripes running the length of the release sheet, parallel to the direction of advancement of the release sheet, and spaced substantially equally across the width of the release sheet. The material was applied in stripes by extrusion through a slot die to give stripes having a width of a quarter to a half of the width of the spacer to be cut.

The stripes of tacky material were applied at a depth such that in the end product, the tacky material would have a depth of about 0.5 mm.

The tacky material was then cured.

A layer of a second, non-tacky material was then applied over the stripes of the first material and the release sheet. The non-tacky material was a plastic composite, such as a composite that comprised PVC resin paste, phthalate plasticiser, azo blowing agent, pigment and ESBO, with amounts of plasticiser only sufficient to soften the resin, such that the composite was non-tacky. The layer of the non-tacky material was applied by using a knife to smooth a layer of the material over all of the stripes of the tacky material and over all of the release sheet.

The layer of non-tacky material was applied at a depth such that in the end product, the non-tacky material would have a depth of about 2 to 3 mm, e.g. 2.5 to 3 mm.

The product was then heated by placing the product into an oven. This heating step acted to “blow” the composite. The heating was at a temperature of about 200° C. for from about 1.5 to 2 minutes.

The resultant product was then cut into a plurality of strips by a knife such that one or more of the cut edges of each strip included a portion of the non-tacky material. The product was cut into strips having a width of about 18 mm.

The product was then cut into lengths of 18 mm, with a knife cutting through the tacky and non-tacky material and partly cutting the release sheet. This partial cutting involved making perforations or cuts across the width or at each edge of the release sheet.

Preferably each spacer generated had an edge portion with non-tacky material but a degree of wastage was acceptable.

Using this method, spacers as shown in FIG. 1 were produced, which had stripes of tacky material able to act to hold the spacer in position to avoid the spacer falling off. A fingerlift function was also achieved for the spacers thus produced, as a non-tacky edge was provided that permits easy removal of the spacer when required.

### Example 1b

A method of manufacturing a plurality of spacers in accordance with the present invention was carried out. The method firstly comprised the provision of a release sheet, such as a sheet of silicone release paper.

Then a plurality of stripes of a first, tacky material were applied to the release sheet. The tacky material was a plastic composite, such as a composite comprising PVC resin paste, phthalate plasticiser, polyester plasticiser, azo blowing agent, pigment and ESBO, with an excess of the polyester plasticiser such that the composite was tacky. The tacky material was applied in continuous stripes running the length of the release sheet, parallel to the direction of advancement of the release sheet, and spaced substantially equally across the width of the release sheet. The material was applied in stripes by extrusion through a slot die to give stripes having a width of a quarter to a half of the width of the spacer to be cut.

The stripes of tacky material were applied at a depth such that in the end product the tacky material would have a depth of about 0.5 mm.

A layer of a second, non-tacky material was then applied directly over the stripes of the first material and the release sheet, without the first material having been cured. The non-tacky material was a plastic composite, such as a composite that comprised PVC resin paste, phthalate plasticiser, azo blowing agent, pigment and ESBO, with amounts of plasticiser only sufficient to soften the resin, such that the composite was non-tacky. The layer of the non-tacky material was applied by using a knife to smooth a layer of the material over all of the stripes of the tacky material and over all of the release sheet.

The layer of non-tacky material was applied at a depth such that in the end product, the non-tacky material would have a depth of about 2 to 3 mm, e.g. 2.5 to 3 mm.

The product was then heated by placing the product into an oven. The heating was at a temperature of about 200° C. for from about 1.5 to 2 minutes.

The resultant product was then cut into a plurality of strips by a knife such that one or more of the cut edges of each strip included a portion of the non-tacky material. The product was cut into strips having a width of about 18 mm.

The product was then cut into lengths of 18 mm, with a knife cutting through the tacky and non-tacky material and partly cutting the release sheet. This partial cutting involved making perforations or cuts across the width or at each edge of the release sheet.

Preferably each spacer generated had an edge portion with non-tacky material but a degree of wastage was acceptable.

Using this method, spacers as shown in FIG. 1 were produced, which had stripes of tacky material able to act to hold the spacer in position to avoid the spacer falling off. A fingerlift function was also achieved for the spacers thus produced, as a non-tacky edge was provided that permits easy removal of the spacer when required.

### Example 2

A method of providing the spacers produced in Example 1 in strips on bobbins for easy dispensing was then carried out. The method firstly involved providing a length of about 400 m of a number of the strips of spacer material produced in Example 1, to provide a total width of material of about 1.5 m.

Each strip was releasably joined to the strip or strips directly adjacent to it by one or more integral bridges that had been formed when cutting the material into strips, by only partially cutting the material.

The strips of material were then wound into a roll, with the strips still held together by the integral bridges.

A stabilising strip, such as strip of polyester, was then provided to give stability to the strips forming the roll. The stabilising strip was stapled to the strips of material making up the half of the roll furthest from the outer edge.

The single strip of material at the outermost edge of the roll was unwound from the outer edge of the roll. The pulling force of unwinding the roll could be used to break the bridges, or bridges could be cut prior to unwinding.

Finally, the unwound strip of material was wound onto a bobbin. The bobbin was used on automatic applicating equipment to apply spacers to glass sheets to help separate them in transit.

1-93. (canceled)

94. A method of manufacturing a plurality of spacers comprising:
a) providing a carrier medium;
b) applying one or more stripes of a first material on a first face of the carrier medium; and
c) applying a layer of a second material over the first face of the carrier medium;
so as to form a substrate on the carrier medium comprising first material and second material;
wherein one of the first and second materials is a material that, in the end spacer product at room temperature, is a tacky material that will readily hold the spacer in place during its intended use, and the other of the first and second materials is a material that, in the end spacer product at room temperature, is a non-tacky material that will substantially not stick to the glass or other material to be separated;
and wherein the stripes of the first material are spaced apart such that when the substrate formed by the first and second materials is cut into strips of a width corresponding to the width of the spacers being produced, one or more of the cut edges of each strip includes a portion of the non-tacky material.

95. The method of claim 94, wherein the method includes the step of:
d) cutting the substrate formed by the first and second materials into a plurality of strips of a width corresponding to the width of the spacers being produced, such that one or more of the cut edges of each strip includes a portion of the non-tacky material.

96. The method of claim 94 wherein the method further includes the step of:
(e) cutting the substrate formed by the first and second materials into spacer sized lengths.

97. The method of claim 94 wherein the method includes the step of heating the product after the layer of the second material has been applied in step (c).

98. The method of claim 94 wherein the second material applied in step (c) does not cover the stripes of first material, and the method includes the further step of treating the tacky material on one face of the substrate formed by the first and second materials such that it becomes substantially non-tacky.

99. The method of claim 94 wherein the tacky material is a plastic composite that comprises resin and plasticiser in an amount in excess of the amount needed to soften the resin.

100. The method of claim 94 wherein the tacky material is a plastic composite comprising resin and plasticiser and tackifier.

101. The method of claim 94 wherein the method includes the further step of rolling the formed product into a roll.

102. The method of claim 94, wherein the method comprises the step of releasing the substrate formed by the first material and second material from the carrier medium.

103. A method of manufacturing a plurality of spacers comprising:
(i) providing a carrier medium; and
(ii) applying a tacky material on a first face of the carrier medium; so as to form a substrate on the carrier medium comprising this tacky material; and then
(iii) treating sections of the surface of the tacky material such that it becomes substantially non-tacky material in these sections, so as to create a surface provided with stripes of tacky material interspaced with stripes of non-tacky material;
wherein the tacky material is material that, in the end spacer product at room temperature, is a tacky material that will readily hold the spacer in place during its intended use, and the non-tacky material is material that, in the end spacer product at room temperature, is a non-tacky material that will substantially not stick to the glass or other material to be separated;
and wherein the stripes of tacky material thus produced are spaced apart such that when the substrate formed by the tacky and non-tacky material is cut into strips of a width corresponding to the width of the spacers being produced, one or more of the cut edges of each strip includes a portion of non-tacky material.

104. A method of manufacturing a plurality of spacers comprising:
(i) providing a carrier medium; and
(ii) applying a non-tacky material on a first face of the carrier medium;
so as to form a substrate on the carrier medium comprising this non-tacky material; and then
(iii) treating sections of the surface of the non-tacky material such that it becomes substantially tacky material in these sections, so as to create a surface provided with stripes of tacky material interspaced with stripes of non-tacky material;
wherein the tacky material is material that, in the end spacer product at room temperature, is a tacky material that will readily hold the spacer in place during its intended use, and the non-tacky material is material that, in the end spacer product at room temperature, is a non-tacky material that will substantially not stick to the glass or other material to be separated;
and wherein the stripes of tacky material thus produced are spaced apart such that when the substrate formed by the tacky and non-tacky material is cut into strips of a width corresponding to the width of the spacers being produced, one or more of the cut edges of each strip includes a portion of non-tacky material.

105. A method according to claim 104 wherein the method includes the step of:
cutting the substrate into a plurality of strips of a width corresponding to the width of the spacers being produced, such that one or more of the cut edges of each strip includes a portion of the non-tacky material.

106. A method according to claim 104 wherein the method includes the step of:
cutting the substrate into spacer sized lengths.

107. A method according to claim 104 wherein the method comprises the step of releasing the substrate from the carrier medium.

108. A method according to claim 104 wherein the method includes the further step of rolling the formed product into a roll.

109. A spacer, suitable for spacing sheets of glass, comprising a pad element that has a first portion made of a tacky material, such that in use at room temperature the face or faces of the pad element that comprise this tacky material that contact a material to be spaced adhere to said tacky material, and a second portion made of a substantially non-tacky material, such that in use at room temperature the face or faces of the pad element that comprise this non-tacky material that contact a material to be spaced do not adhere to said material,
wherein at least part of the first portion is located at a face of the pad element, at least part of the second portion is located at an edge of the pad element and wherein the pad element is sufficiently flexible that the second portion can be bent out of a plane which the first portion occupies so that during removal of the pad element from said material said second portion is finger liftable relative to the material to which said first portion is adhered when in use.

110. A stack of two or more sheets of material wherein each sheet is separated by one or more spacers according to claim 109.

111. A method of winding long lengths of material into a roll, which method comprises:
(a) providing a length of material cut into strips of a desired width along its length, with each strip being joined to the strip or strips directly adjacent to it by means of one or more bridges; and
(b) winding the strips of material into a roll.

112. A method according to claim 111 wherein the material provided in step (a) has been produced by the method of claim 94.

113. A method of producing a bobbin wound with material, which method comprises:
(a) providing a roll of material comprising strips of material, with each strip being wound into a roll and joined to the strip or strips directly adjacent to it by means of one or more bridges;
(b) unwinding a strip of material from the roll; and
(c) winding said strip onto a bobbin.

114. A method according to claim 113 wherein the roll of material provided in step (a) has been produced by the method of claim 111.

115. A roll of a length of material, wherein the length of material is cut into strips of a desired width along its length, with each strip being joined to the strip or strips directly adjacent to it by means of one or more bridges.

116. A roll according to claim 115 wherein the material has been produced by the method of claim 94.

117. The method of claim 94, wherein the tacky material is not a pressure sensitive adhesive.

118. The method of claim 94, wherein the tacky material is an expanded or expandable material.

119. A method according to claim 103 wherein the method includes the step of:
cutting the substrate into a plurality of strips of a width corresponding to the width of the spacers being produced, such that one or more of the cut edges of each strip includes a portion of the non-tacky material.

120. A method according to claim 103 wherein the method includes the step of:
cutting the substrate into spacer sized lengths.

121. A method according to claim 103 wherein the method comprises the step of releasing the substrate from the carrier medium.

122. A method according to claim 103 wherein the method includes the further step of rolling the formed product into a roll.

123. The method of claim 111, wherein two or more rolls are combined in a master roll and the pulling force of unwinding one or more roll from the master roll may be used to break the bridges.

124. A method according to claim 113 wherein the roll of material provided in step (a) has been produced by the method of claim 111.
